(19) United States
(12) Patent Application Publication
(10) Pub. No.: US 2001/0022872 A1
(43) Pub. Date: Sep. 20, 2001

(54) Bearing assembly between head tube and steerer tube

(76) Inventor: Kohei Marui, Kobe (JP)

Correspondence Address: BACON & THOMAS, PLLC, 625 Slaters Lane, 4th Floor, Alexandria, VA, 22314-1176, US

(21) Appl. No.: 09/804,181

(22) Filed: Mar. 13, 2001

(30) Foreign Application Priority Data
Mar. 14, 2000 (TW) 89204043

(51) Int. Cl. F16C 13/00

(52) U.S. Cl. 384/545

(57) ABSTRACT

A bearing assembly includes a head tube (10) through which a steerer tube (21) of the front fork (20) extends. A first annular flange (45) and a second annular flange (53) extend from an inner periphery of the head tube. An upper bearing (44) and a lower bearing (52) are respectively received in two ends of the head tube and contact the first annular flange and the second annular flange. A first ring (43) and a second ring (50) are respectively received in the head tube and press on the two bearings. A cap (41) is securely mounted to the steerer tube and compresses on the first ring and the second ring is positioned on a crown portion of the front fork.

### FIELD OF THE INVENTION

The present invention relates to a bearing assembly for bicycles wherein the bearing assembly is hid in the head tube and can be used on threaded steerer tube or non-thread steerer tube.

### BACKGROUND OF THE INVENTION

A conventional bearing assembly known to applicant is shown in FIGS. 4 and 5, and generally includes a steerer tube 71 on a font fork 70 and the steerer tube 71 extends through a head tube 60 which has a sink hole 62/64 defined in two ends thereof so that an upper bearing 63 and a lower bearing 630 are respectively engaged with the two sink holes 62 and 64 and respectively mounted on the steerer tube 80. A handlebar stem 80 is fixedly engaged with a passage in the steerer tube 71. The steerer tube 71 has a threaded outer periphery and a locking nut 90 is securely mounted to the threaded outer periphery and compresses the upper bearing 63 in position. A cap 91 is engaged with an upper end of the head tube 60 to seal a gap between the handlebar stem 80 and the head tube 60. By this way, the bearings 63, 630 are hid in the head tube 60. However, in order to drill the sink holes 62 and 64, the manufacturers have to use special machine or tools to obtain precise sink holes 62, 64 so that the bearings 63, 630 can be installed correctly. It is difficult to replace or access the bearings 63, 630 and requires special tools to reach the bearings 63, 630. The conventional bearing assemblies can only be used with threaded steerer tube 71.

The present invention intends to provide a bearing assembly that can be used with non-thread steerer tube and the head tube does not need to be machined to have sink holes as shown in the conventional bearing assembly.

### SUMMARY OF THE INVENTION

In accordance with one aspect of the present invention, there is provided a bearing assembly and comprising a head tube which has a first annular flange and a second annular flange extending from an inner periphery of the head tube. Each of the first flange and the second flange has a tapered surface. An upper bearing is received in a first end of the head tube and supported on the tapered surface of the first annular flange. A first ring is engaged with the first end of the head tube and has a tapered surface which contacts on the upper bearing. A lower bearing is received in a second end of the head tube and contacts the tapered surface of the second annular flange. A second ring is engaged with the second end of the head tube and has a tapered surface which contacts the lower bearing. A cap is mounted to a steerer tube extending through the head tube and seals the first end of the head tube.

The primary object of the present invention is to provide a bearing assembly for bicycles wherein the head tube has two flanges to engage with the upper and lower bearing assemblies.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a head tube with a steerer tube of a front fork extending therethrough, the bearing assembly of the present invention is received in the head tube;

FIG. 2 is an exploded view to show the bearing assembly of the present invention;

FIG. 3 is a cross sectional view to show the bearing assembly of the present invention received in the head tube;

FIG. 4 is a cross sectional view to show a conventional bearing assembly of bicycles, and

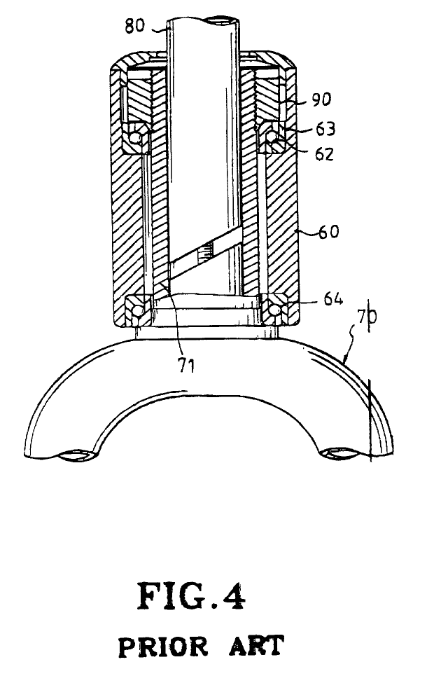

FIG. 5 is an exploded view to show the conventional bearing assembly.

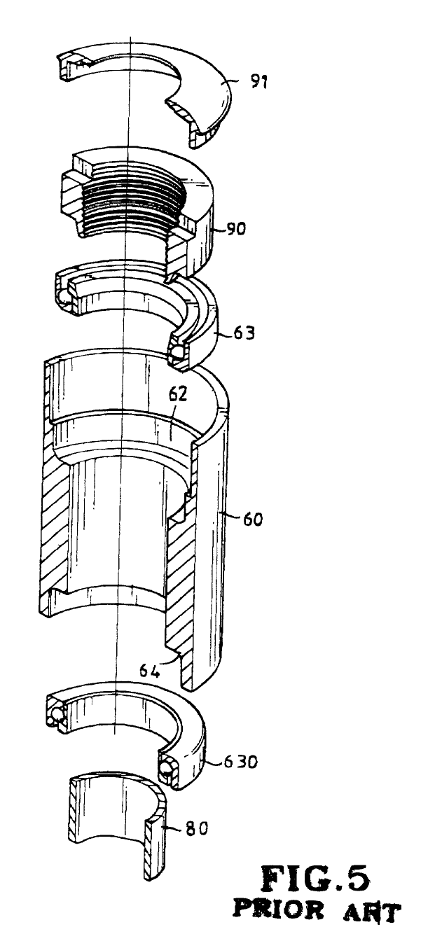

### DETAILED DESCRIPTION OF THE PREFERRED EMBODIMENT

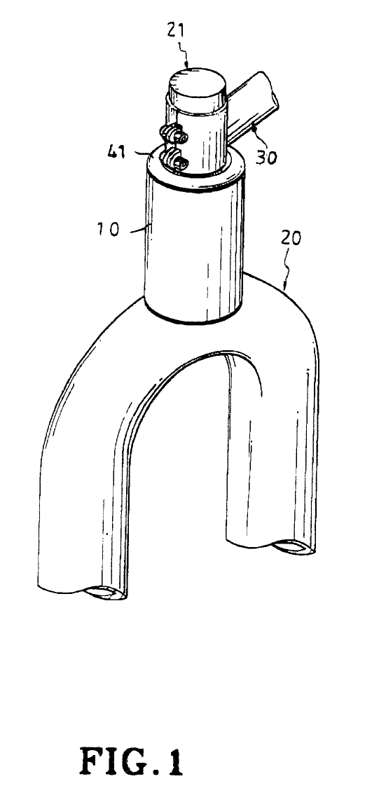

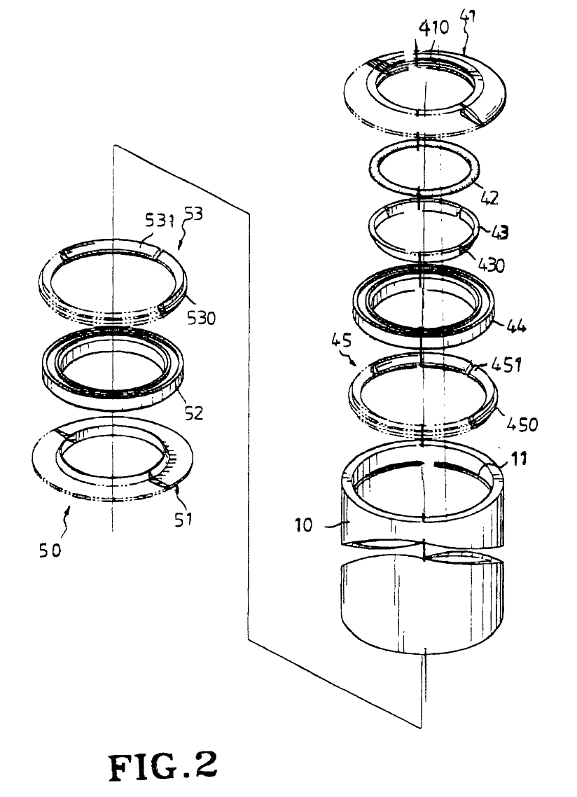

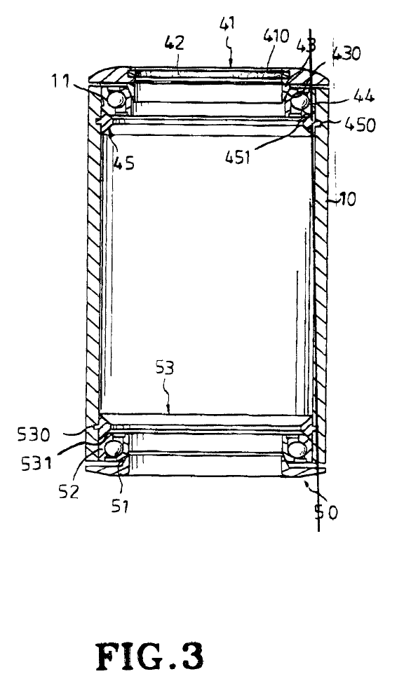

Referring to FIGS. 1 to 3, the bearing assembly for bicycles of the present invention comprises a head tube 10 through which a steerer tube 21 of a front fork 20 extends and a handlebar assembly 30 is connected to the steerer tube 21. Two grooves 11 are defined in the inner periphery of the head tube 10. A first annular flange 45 and a second annular flange 53 each have an annular lip 450/530 which is engaged with respective one of the two annular grooves 11. Each of the first flange 45 and the second flange 53 has a tapered surface 451/531 and each of the first flange 45 and the second flange 53 is a C-shaped member so that they can be adjusted in diameter when a load applied thereon.

An upper bearing 44 is received in a first end of the head tube 10 and is supported on the tapered surface 451 of the first annular flange 45. A first ring 43 is engaged with the first end of the head tube 10 and has a tapered surface 430 which contacts on the upper bearing 44. The upper bearing 44 is positioned between the first ring 43 and the first annular flange 45. A lower bearing 52 is received in a second end of the head tube 10 and contacts the tapered surface 531 of the second annular flange 53. A second ring 50 is engaged with the second end of the head tube 10 and has a tapered surface 51 which contacts the lower bearing 52. The lower bearing 52 is positioned between the second annular flange 53 and the second ring 50 which is mounted on a crown portion of the front fork 20.

A cap 41 is mounted to the steerer tube 21 and seals the first end of the head tube 10 and presses on the first ring 43 which compresses the upper bearing 44. A groove 410 is defined in an inner periphery of the cap 41 and a seal 42 is engaged with the groove 410 in the cap 41 so as to prevent rain drops entering the head tube 10.

Accordingly, the head tube 10 does not be required to have sink holes on two ends thereof and the bearing assembly can be used on threaded or non-thread steerer tube.

While we have shown and described the embodiment in accordance with the present invention, it should be clear to those skilled in the art that further embodiments may be made without departing from the scope of the present invention.

What is claimed is:

1. A bearing assembly comprising:
a head tube having a first annular flange and a second annular flange extending from an inner periphery of said head tube, each of said first flange and said second flange having a tapered surface;
an upper bearing received in a first end of said head tube and supported on said tapered surface of said first annular flange, a first ring engaged with said first end of said head tube and having a tapered surface which contacts on said upper bearing,
a lower bearing received in a second end of said head tube and contacting said tapered surface of said second annular flange, a second ring engaged with said second end of said head tube and having a tapered surface which contacts said lower bearing, and
a cap sealing said first end of said head tube and pressing on said first ring.

2. The assembly as claimed in claim 1, wherein said head tube has two grooves defined in said inner periphery thereof and each of said first annular flanges and said second annular flange having an annular lip which is engaged with respective one of said two annular grooves.

3. The assembly as claimed in claim 2, wherein each of said first annular flanges and said second annular flange is a C-shaped member.

4. The assembly as claimed in claim 1 further comprising a groove defined in an inner periphery of said cap and a seal engaged with said groove in said cap.

5. The assembly as claimed in claim 1 wherein said first ring is a C-shaped member.
